(19) United States
(12) Patent Application Publication
(10) Pub. No.: US 2018/0084597 A1
(43) Pub. Date: Mar. 22, 2018

(54) METHOD OF MANAGING COMMUNICATION INTERFACES FOR A MULTIPATH TRANSMISSION CONTROL PROTOCOL (MPTCP) CONNECTION

(71) Applicant: Samsung Electronics Co., Ltd., Suwon-si (KR)

(72) Inventors: Madhan Raj Kanagarathinam, Bangalore (IN); Siva Sabareesh Dronamraju, Bangalore (IN); Kyoung-Jin Moon, Yongin-si (KR)

(21) Appl. No.: 15/458,766

(22) Filed: Mar. 14, 2017

(30) Foreign Application Priority Data
Sep. 19, 2016 (IN) 5046/CHE/2015

(51) Int. Cl. H04W 76/02; H04B 1/3827

(52) U.S. Cl. CPC H04W 76/025; H04W 76/027; H04B 1/385

(57) ABSTRACT

Embodiments herein provide a method for communication by a device using a multipath transmission control protocol (MPTCP) connection. The method comprises establishing communication with an endpoint using a primary interface of the device, detecting an event in the device, and switching an interface for communication with the endpoint, from the primary interface to a secondary interface of the device according to the detected event.

### CROSS-REFERENCE TO RELATED APPLICATION(S) AND CLAIM OF PRIORITY

The present application is related to and claims the priority under 35 U.S.C. § 119(a) to Indian Patent Application No. 5046/CHE/2015, which was filed in the Indian Patent Office on Sep. 19, 2016, the entire content of which is hereby incorporated by reference.

### TECHNICAL FIELD

The present invention relates to multiple communication interfaces, and more particularly, to a method of managing communication interfaces for a multipath transmission control protocol (MPTCP) connection.

### BACKGROUND

Almost all the modern mobile devices come up with multiple networking communication interfaces. The presence of the multiple communication interfaces can provide solution for smooth operations during vertical and horizontal handover condition, so that the end-to-end performance for the user would not be impacted. Various solutions have been proposed at different layers such as application layer mobility (HTTP caching, range request, etc), network layer such as (Mobile IP, PMIP, etc). However, each comes up with their own problem. The application layer mobility requires each application to be modified and would be application dependent and complex and it would be specific to particular application protocol. For example, when only hypertext transfer protocol (HTTP) is supported, if plain file transfer protocol (FTP) is used it fails to provide mobility. In case of network/PHY or lower layer mobility solution, there is a need for the mode or path of the multi-network session to be tightly coupled i.e. there must be some common entity which would device the control parameters and switch at the lower layers. However, the mobility ceases to exist if the multi interfaces goes off path or heterogeneous connection. For example, interface 1 is connected to operator 1 which goes through gateway 1 and interface 2 is connected to another operator 2 which goes through gateway 2.

The conventional methods either work with fixed interface being primary interface (PI) or switching the PI during the connection failure. When the PI is fixed the conventional methods suffers with the problems of connection failure and poor performance. If the PI is connected but does not have internet access then the end user will suffer from the connection failure i.e. even if there are two interfaces up and connected, if the PI does not have internet the user cannot access internet. When the PI is fixed then the backup interface would also be fixed, there might be excess power consumption as the interface is up and connected even when it is not required.

In the conventional methods throughput failure occurs when the PI is selected based on connection status. Most of the MPTCP scheduler tries to push the packet as much in the PI and then try for the other subflows. If the PI is selected as the best interface, the throughput is observed to be delivered the best. When PI is behind a middlebox which strips down the MPTCP options, the connection would fallback to regular TCP regardless of the fact that multiple interfaces are available.

The above information is presented as background information only to help the reader to understand the present invention. Applicants have made no determination and make no assertion as to whether any of the above might be applicable as Prior Art with regard to the present application.

### SUMMARY

To address the above-discussed deficiencies, it is an object to provide a method of managing communication interfaces for a multipath transmission control protocol (MPTCP) connection.

Another object of the embodiments herein is to provide a method for detecting an event in a communication device and dynamically switch from a first interface to a second interface in accordance to the detected event.

Another object of the embodiments herein is to provide a method for travel mode working in real simultaneous dual band (RSDB) conditions.

Another object of the embodiments herein is to provide a method for travel mode working by multiplexing of the data connection using single interface.

Another object of the embodiments herein is to provide a method for travel mode enhancement with the help of location information.

Accordingly the embodiments herein provide a method for communication by a device using a multipath transmission control protocol (MPTCP) connection. The method comprises establishing communication with an endpoint using a primary interface of the device, detecting an event in the device, and switching an interface for communication with the endpoint, from the primary interface to a secondary interface of the device according to the detected event.

Accordingly the embodiments herein provide a device for communication using a multipath transmission control protocol (MPTCP) connection. The device comprises a primary interface, a secondary interface, and a controller coupled to the primary interface and the secondary interface, wherein the controller is configured to, establish communication with an endpoint using a primary interface of the device, detect an event in the device, and switch an interface for the communication with the endpoint, from the primary interface to a secondary interface of the device according to the detected event.

Accordingly the embodiments herein provide A computer program product for communication by a device using a multipath transmission control protocol (MPTCP) connection, comprising computer executable program code recorded on a computer readable non-transitory storage medium. The computer executable program code when executed causing the actions including establishing communication with an endpoint using a primary interface of the device, detecting an event in the device; and switching an interface for communication with the endpoint, from the primary interface to a secondary interface of the device according to the detected event.

In an embodiment, the event corresponds to a connection failure, a change in signal strength, a change in location and a change in throughput.

In an embodiment, the proposed method includes creating the primary interface as backup prior to establishing the data communication with the endpoint.

In an embodiment, the proposed method includes creating the primary interface as backup after establishing the data communication with the endpoint, wherein the primary interface is created as backup in response to a pre-defined condition.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the architecture of a communication device for managing communication interfaces for a multipath transmission control protocol (MPTCP) connection, according to embodiments as disclosed herein;

FIG. 2 is a state diagram illustrating connection status of the communication interfaces, according to embodiments as disclosed herein;

FIG. 3 is a flow diagram illustrating a method of managing communication interfaces for a MPTCP connection, according to embodiments as disclosed herein;

FIG. 4 shows a sequence diagram depicting an example scenario of location Switching, according to embodiments as disclosed herein;

FIG. 5 shows a sequence diagram depicting an example scenario of real simultaneous dual band (RSDB), according to embodiments as disclosed herein;

FIG. 6 shows a sequence diagram depicting an example scenario of single Wi-Fi multiplex mode, according to embodiments as disclosed herein;

FIG. 7 shows a sequence diagram depicting an example scenario of seamless connectivity with dual SIM dual active (DSDA) mobile devices, according to embodiments as disclosed herein;

FIG. 8 shows a sequence diagram depicting an example scenario of seamless connectivity with dual SIM dual standby (DSDS) devices, according to embodiments as disclosed herein;

FIG. 9 shows a sequence diagram depicting an example scenario of seamless connectivity in vertical handover, according to embodiments as disclosed herein;

FIG. 10 shows a sequence diagram depicting an example scenario of seamless connectivity in vertical handover, according to embodiments as disclosed herein; and

FIG. 11 illustrates a computing environment implementing a method of managing communication interfaces for a multipath transmission control protocol (MPTCP) connection, according to an embodiment as disclosed herein.

### DETAILED DESCRIPTION

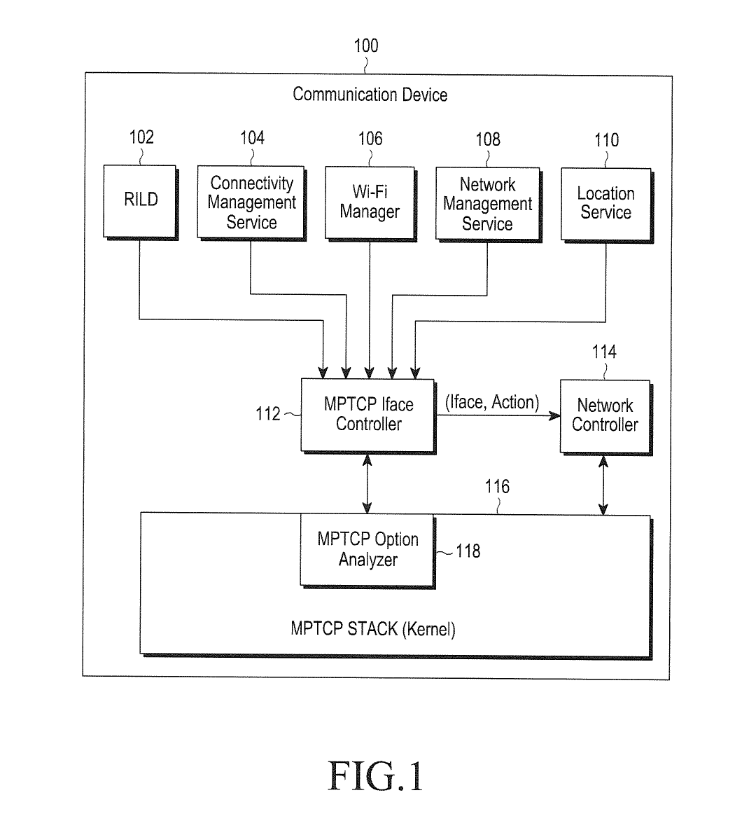

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Accordingly the embodiments herein provide a method of managing communication interfaces for a multipath transmission control protocol (MPTCP) connection. The method includes detecting an event in a communication device, wherein the event is detected when a primary interface is in a data communication with an end point. Further, the method includes dynamically switching from the primary interface to a secondary interface in accordance to the detected event.

In an embodiment, the event corresponds to a connection failure, a change in signal strength, a change in location and a change in throughput.

In an embodiment, the proposed method includes creating the primary interface as backup prior to establishing the data communication with the endpoint.

In an embodiment, the proposed method includes creating the primary interface as backup after establishing the data communication with the endpoint, wherein the primary interface is created as backup in response to a pre-defined condition.

In day to day life, the user is connected to public Wi-Fi and moves from one place to the other. The user expects seamless connectivity without any termination or reconnection of the data. Due to changes in the routers or the wireless AP, the session would be disconnected each time and a new session would be started. In case of HTTP kind of protocol, it might recover back and in case of plain TCP and other protocol the session would be completely lost and couldn't be recovered.

The proposed method and system provides dynamic switching of primary interface to provide better throughput and to fully utilize the functionality of the MPTCP at the most when available.

The proposed method and system of dynamically switching the primary interface to provide seamless connectivity to the end-user without any disconnection of the data connectivity by combinations of user available network communication interfaces; user location based details; and user history based learning and other current network and operational conditions to deliver the best seamless connectivity as possible.

In an embodiment, the proposed invention provides a method to detect the MPTCP health from three way handshake (SYN, SYN/ACK and ACK).

In another embodiment, the proposed invention provides a method that would set/switch/turn on/tear down/linger the network interface according to the passed controlled message.

In another embodiment, the proposed invention provides a method that would listen to the other framework and lower level components and inform the network controller to perform particular option.

In another embodiment, the proposed method provides the full utilization of MPTCP when it is in full mesh mode.

In another embodiment, the proposed method provides power saving when it is in backup mode.

A new feature could be added in the settings, with user selectable option and/or could be extended as feature without any user interface (UI)/user experience (UX) change based on the learning of the user activity. A quick access button also could be added in case of user selection.

In an embodiment, the method can be extended along with location service data base to improve the server offloading capability.

Referring now to the drawings, and more particularly to FIGS. 1 through 11, where similar reference characters denote corresponding features consistently throughout the figures, there are shown preferred embodiments.

FIG. 1 illustrates the architecture of a communication device for managing communication interfaces for a multipath transmission control protocol (MPTCP) connection, according to embodiments as disclosed herein. As depicted in FIG. 1, the communication device 100 includes a radio interface layer daemon (RILD) 102, a connectivity management service 104, a Wi-Fi manager 106, a network management service 108, a location service 110, a MPTCP interface (MPTCP Iface) controller 112, a network controller 114, a MPTCP stack (kernel) 116 and a MPTCP option analyzer 118. The RILD 102 is to establish radio connections i.e. radio events for example signal strength, signal power and amount of data sent or the like. The connectivity management service 104, the Wi-Fi manager 106 and the network management service 108 is to manage connection establishment. The location service 110 provides the exact location coordinates of the communication device 100 and provides the preferred interface according to the user interest or the operator interest based on the location. The MPTCP Iface controller 112 sends the interface (Iface) (i.e. which interface to be selected as primary) and the action (for example backup, fullmesh, disconnect or the like indicating the mode) to be performed to the network controller 114. The network controller 114 controls the multiple network communication interfaces to be used as primary and secondary or backup. The MPTCP kernel 116 includes the MPTCP option analyzer 118 which detects the middleboxes. The MPTCP option analyzer checks for the MPTCP option i.e. whether proper option is received or not, and will communicate to the MPTCP IFACE controller 112. For example when the received SYN/ACK for first interface (Wi-Fi1) does not have a MPTCP option, the SYN/ACK will go to MPTCP stack kernel 116 and then the MPTCP option analyzer 118. The MPTCP option analyzer 118 finds that the received SYN/ACK does not have an MPTCP option and indicates it to the MPTCP Iface controller 112. The MPTCP Iface controller 112 sends another interface (Wi-Fi) and tells the network controller 114 to switch the primary interface from the first interface (Wi-Fi1) to the other interface (Wi-Fi2) and either to disconnect or backup the first interface (Wi-Fi1) with no MPTCP option.

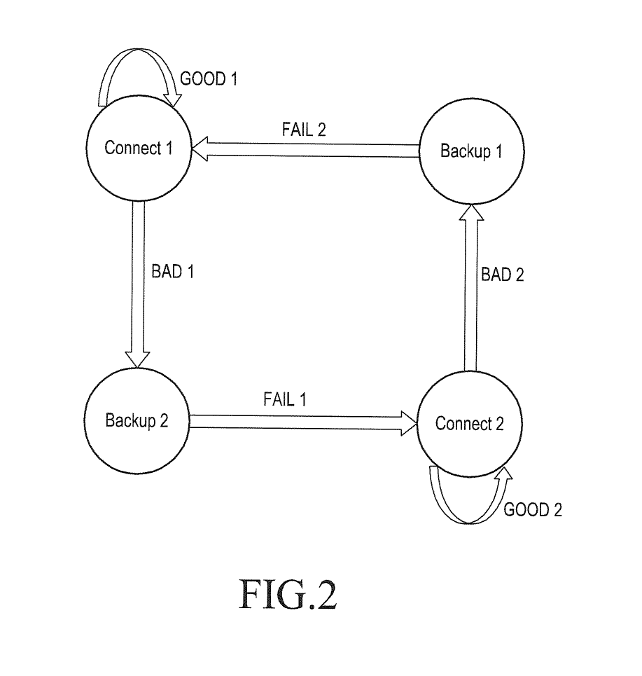

FIG. 2 is a state diagram illustrating the connection status of the communication interfaces, according to embodiments as disclosed herein. FIG. 2 provides solutions for when to connect first interface and when to connect second interface. As depicted in FIG. 2, when first interface is connected (Connect 1) and as long as the connection is good (Good 1), then first interface is held connected. When an event for example a change in signal strength, no network or the like associated with first interface is detected (i.e. Bad 1), a second interface is set backup (Backup 2). Now, the first interface and the second interface is same connection to the above layer. The first interface fails (Fail 1), when an event for example connection failure, throughput failure, location failure or the like associated with the first interface is detected. After the failure (Fail 1) of the first interface, the second interface which is set backup (Backup 2) initially is connected (Connect 2). The second interface is held connected till the connection is good (Good 2). When an event associated with the second interface is detected (Bad 2), the first interface is set backup (Backup 1). Once the second interface connection fails (Fail 2), the first interface gets connected again (Connect1) and the entire process cycle through to provide seamless connectivity and better throughput.

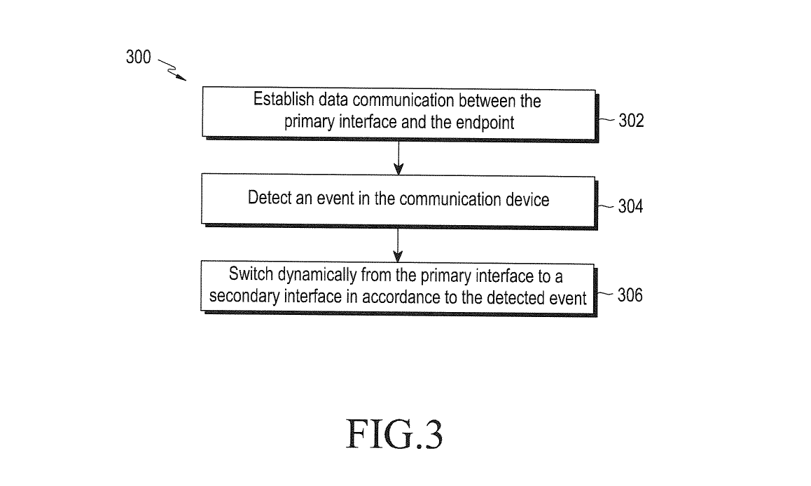

FIG. 3 is a flow diagram illustrating a method of managing communication interfaces for a MPTCP connection, according to embodiments as disclosed herein. In an embodiment, at step 302, the method 300 includes establishing a data communication between a primary interface and an endpoint. In an embodiment, the method 300 allows creating the PI as backup prior to establishing the data communication with the endpoint.

At step 304, the method 300 includes detecting an event in the communication device 100. The method 300 allows the communication device 100 to detect an event corresponding to the primary interface. In an embodiment, the event corresponds to a connection failure, a change in signal strength, a change in location, a change in throughput or the like. In an embodiment, the method 300 allows creating the PI as backup prior to the event in response to a pre-defined condition, after establishing the data communication with the endpoint.

At step 306, the method 300 includes dynamically switching from the primary interface (PI) to a secondary interface (SI) in accordance to the detected event. The method 300 allows the MPTCP option analyzer 118 to detect the MPTCP option from the three way handshake (SYN, SYN/ACK and ACK) with the network controller 114. Further, the method 300 allows the MPTCP Iface controller 112 to listen to the other framework and lower level components and inform the network controller 114 to perform particular option. Furthermore, the method 300 allows the network controller 114 to dynamically switch the network interface according to the controlled message received from the MPTCP IFACE controller 112.

In an embodiment, when the PI sends SYN to the endpoint and does not receive SYN/ACK in return from the endpoint, there is a connection failure and the PI should be switched.

In an embodiment, when the PI sends SYN to the endpoint and receives SYN/ACK without MPTCP option, there is a middlebox problem associated with the PI and the PI should be switched.

In an embodiment, if the round trip time of the TCP (RTT) for the PI (RTT_PI) is greater than the RTT of the SI (RTT_PI) or difference between the RTT_PI and RTT_PI is greater than a threshold value of RTT (RTT_TH), then there is a throughput problem and in order to get a better throughput, the PI could be switched.

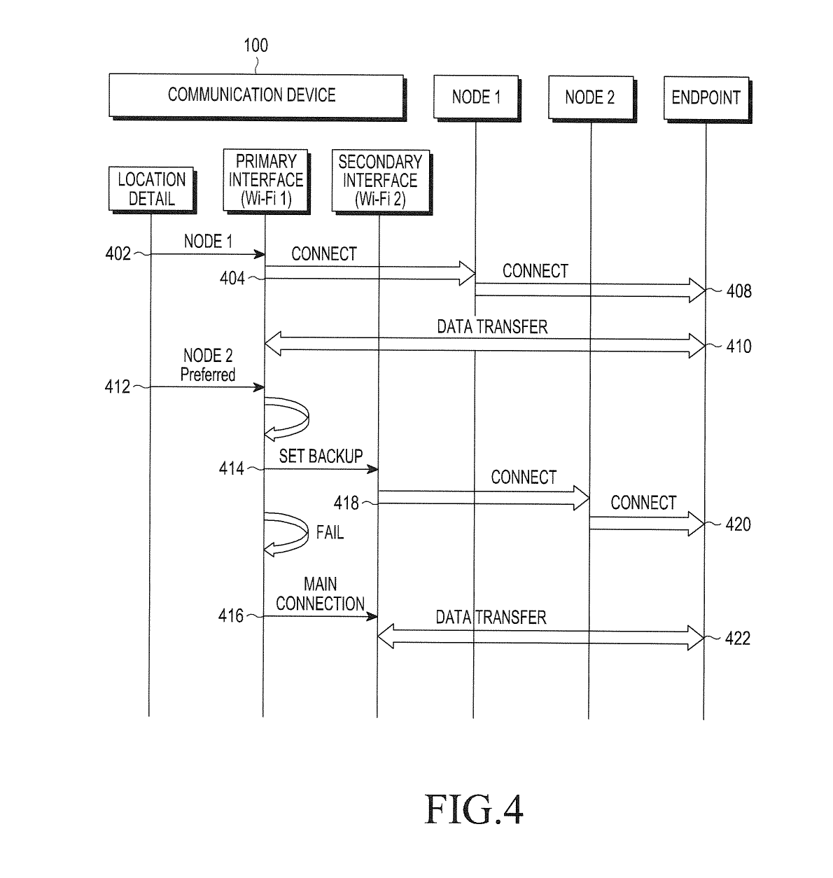

FIG. 4 shows a sequence diagram depicting an example scenario of location switching, according to embodiments as disclosed herein. In an embodiment, as depicted in FIG. 4, PI and SI can both be Wi-Fi for example Wi-Fi 1 and Wi-Fi 2 respectively. At step 402, the location service 110 of the communication device 100 provides the location details of the communication device with respect to PI. At steps 404 and 406 respectively, the PI gets connected to the endpoint (for example a server) through node 1 (for example node can be a router) and the data transfer happens at step 410. At step 412, when there is a change in the location when the communication device moves from one location to another location where node 2 is preferred over node 1, the PI is set as backup at 414. If the PI fails due to an event detected such as location failure or connection failure or throughput failure, then the PI is switched dynamically (step 416) and the SI now becomes the primary and gets connected to the endpoint (step 420) through node 2 (step 416). At step 422, the data is transferred to the SI.

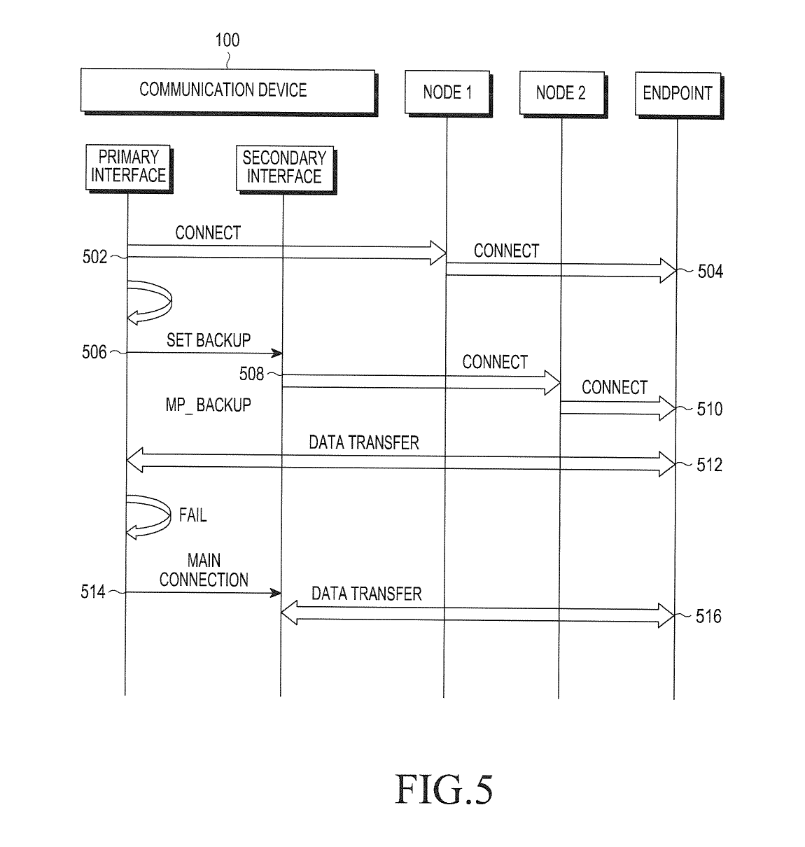

FIG. 5 shows a sequence diagram depicting an example scenario of real simultaneous dual band (RSDB), according to embodiments as disclosed herein. The FIG. 5 shows a multi interface communication device 100, where both the PI and SI are Wi-Fi connections i.e. Wi-Fi 1 and Wi-Fi 2 respectively. At step 502, the Wi-Fi1 is connected to node 1 and then is connected to the endpoint (step 504) through node1. At step 506 the Wi-Fi 2 is set as backup and is connected (at step 508) through node 2 to the endpoint (510). At step 512, the data transfer happens from the endpoint to the Wi-Fi 1. If the Wi-Fi 1 fails, the Wi-Fi 2 becomes the PI i.e. the main connection (514) and the data is transferred (step 516) from the endpoint to the Wi-Fi 2.

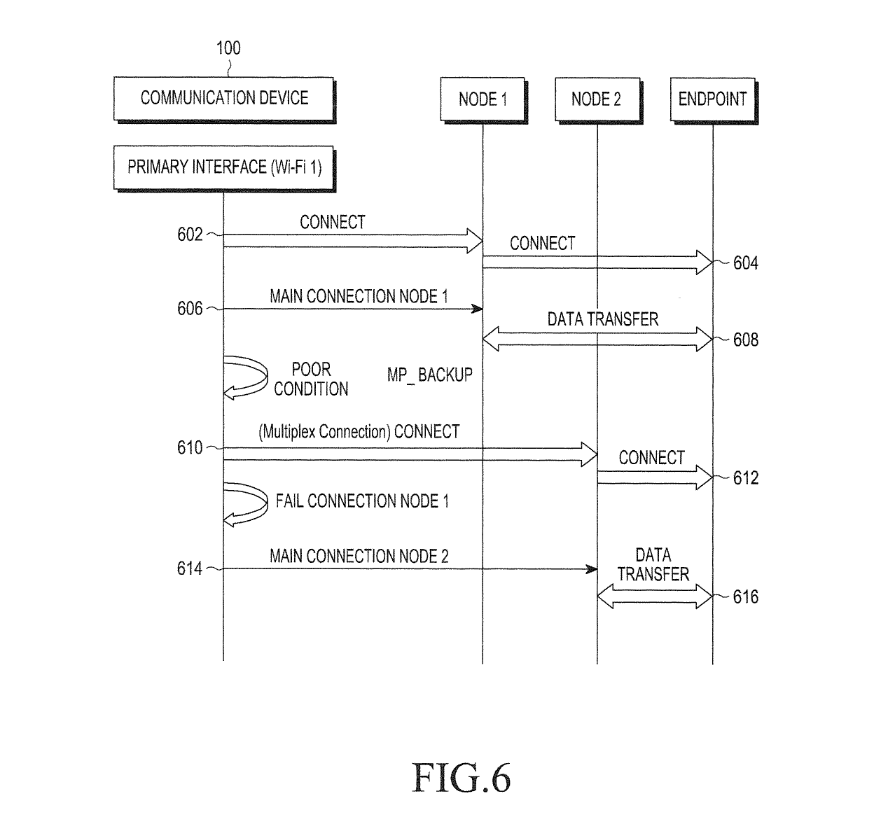

FIG. 6 shows a sequence diagram depicting an example scenario of single Wi-Fi multiplex mode, according to embodiments as disclosed herein. As depicted in FIG. 6, the communication device 100 has a single PI (Wi-Fi 1) and is seamlessly connected to the endpoint by multiplexing node 1 and node 2. The Wi-Fi 1 is connected to the endpoint (step 604) through node 1 (step 602). Now node 1 becomes the main connection (step 606) and the data is transferred (step 608) to node 1. In case of poor condition like weak signal strength for Wi-Fi 1 through node 1, node 2 is set as MP backup and the Wi-Fi 1 is connected (step 612) to the endpoint through the multiplex connection of node 2. If the connection of Wi-Fi 1 through node 1 fails due to connection failure or throughput failure, then the main connection of the Wi-Fi 1 is switched to the node 2 (step 614) and the data is transferred (step 616) from the endpoint to the node 2.

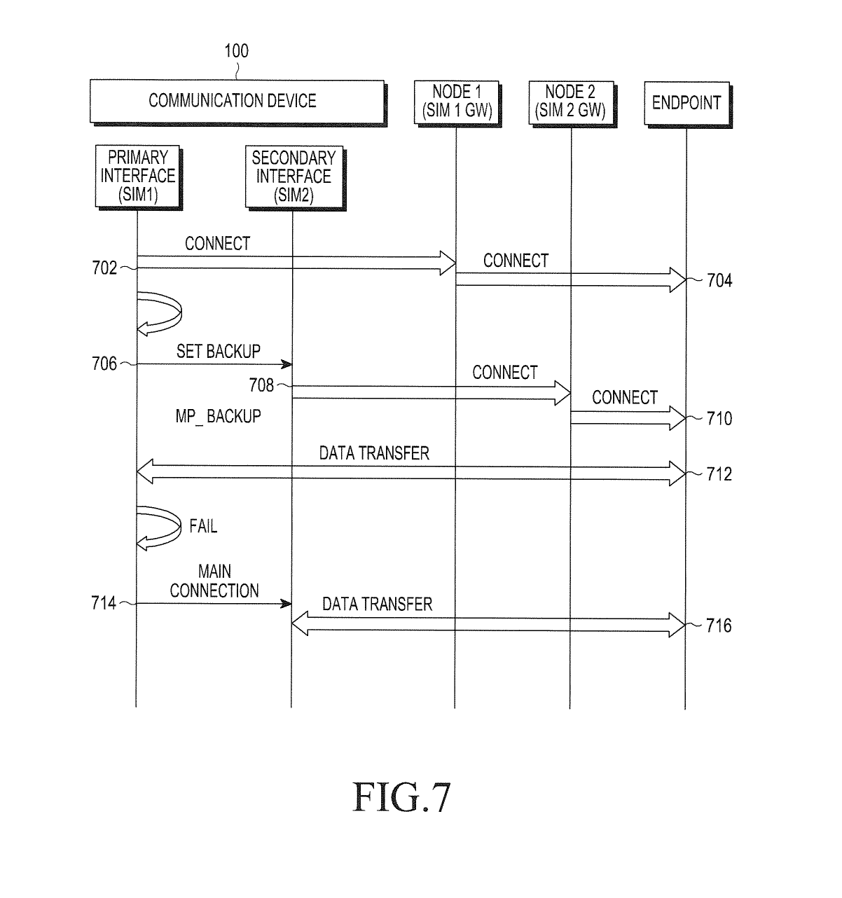

FIG. 7 shows a sequence diagram depicting an example scenario of seamless connectivity with dual SIM dual active (DSDA) mobile devices, according to embodiments as disclosed herein. In an embodiment, as depicted in FIG. 7, the method 300 is applicable in horizontal mobile network handover such as DSDA devices. The FIG. 7 shows a multi interface communication device 100, where both the PI and SI are subscriber identity modules (SIM 1 and SIM 2 respectively). At step 702, the SIM 1 is connected to node 1 (SIM 1 gateway) and then is connected to the endpoint (step 704) through node1. At step 706 the SIM 2 is set as backup and is connected (at step 708) through node 2 (SIM 2 gateway) to the endpoint (step 710). At step 512, the data transfer happens from the endpoint to the SIM 1. If the SIM 1 fails due to a connection failure or throughput failure or the like, then the SIM 2 becomes the primary interface i.e. the main connection (714) and now the data is transferred (step 716) from the endpoint to the SIM 2.

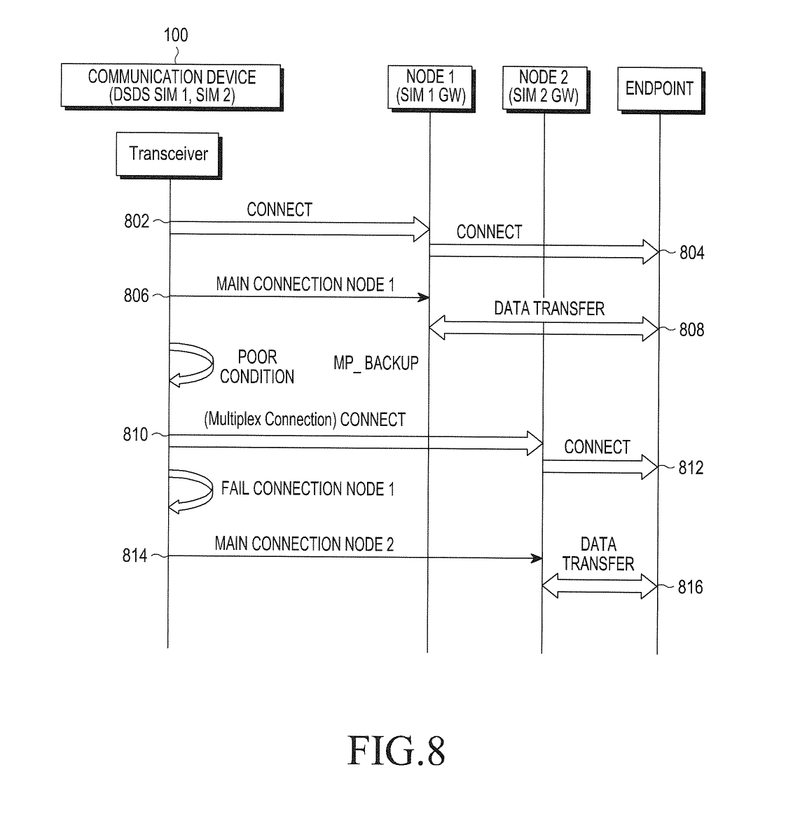

FIG. 8 shows a sequence diagram depicting an example scenario of seamless connectivity with dual SIM dual standby (DSDS) devices, according to embodiments as disclosed herein. In an embodiment, as depicted in FIG. 8, the method 300 can be applicable in horizontal mobile network handover such as DSDS devices. The DSDS communication device 100 consists of dual SIMs, SIM 1 and SIM 2 respectively and a single transceiver. The transceiver is seamlessly connected to the endpoint by multiplexing node 1 (SIM 1 gateway) and node 2 (SIM 2 gateway). The transceiver is connected to the endpoint (step 804) through node 1 (step 802). Now node 1 becomes the main connection (step 806) and the data is transferred (step 808) to node 1. In case of poor condition like weak signal strength for transceiver through node 1, the node 2 is set as MP backup and the transceiver is connected (step 812) to the endpoint through the multiplex connection of node 2. If the connection of transceiver through node 1 fails due to connection failure or throughput failure, the main connection of the transceiver is switched to the node 2 (step 814) and the data is transferred (step 816) from the endpoint to the node 2.

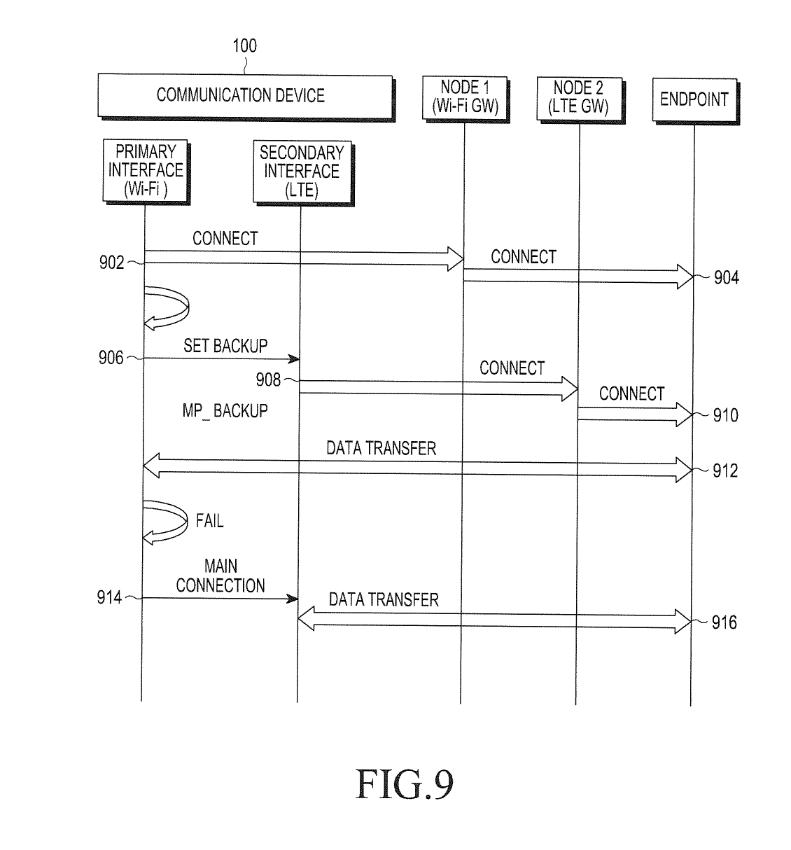

FIG. 9 shows a sequence diagram depicting an example scenario of seamless connectivity in vertical handover, according to embodiments as disclosed herein. In an embodiment, as depicted in FIG. 9, the method 300 can be applicable in vertical handover of PI (Wi-Fi) and SI such as mobile network (long term evolution, LTE). At step 902, the Wi-Fi is connected to node 1 (Wi-Fi gateway) and then is connected to the endpoint (step 904) through node 1. At step 906 the mobile network (LTE) is set as backup and is connected (at step 908) through node 2 (LTE gateway) to the endpoint (step 910). At step 912, the data transfer happens from the endpoint to the Wi-Fi. If the Wi-Fi fails due to a connection failure or throughput failure or the like, the LTE becomes the primary interface i.e. the main connection (914) and now the data is transferred (step 916) from the endpoint to the LTE.

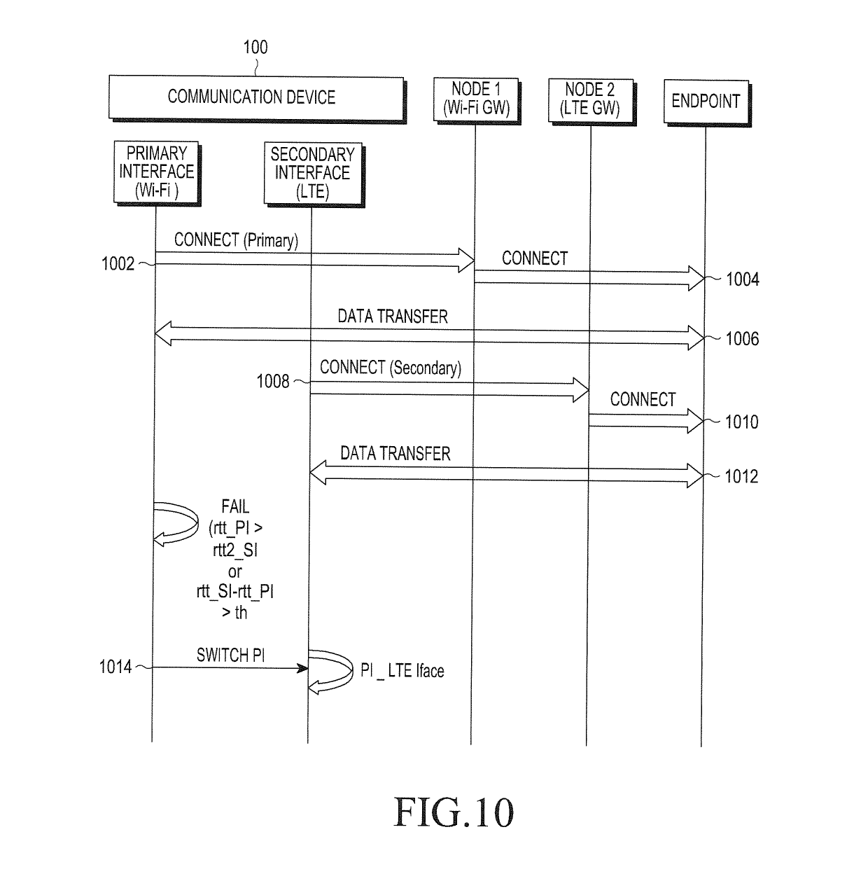

FIG. 10 shows a sequence diagram depicting an example scenario of seamless connectivity in vertical handover, according to embodiments as disclosed herein. In an embodiment, as depicted in FIG. 10, the method 300 can be applicable in vertical handover of PI (Wi-Fi) and SI such as mobile network (long term evolution, LTE). At step 1002, the PI (Wi-Fi) is connected to node 1 (Wi-Fi gateway) and then is connected to the endpoint (step 1004) through node 1. At step 1006, the data is transferred from the endpoint to the PI (Wi-Fi). At step 1008, the SI (LTE) is connected (step 1010) to the endpoint through node 2 (LTE gateway). At step 1012, the data is transferred from the endpoint to the SI (LTE). If the round trip time of the TCP (RTT) for the PI (RTT_PI) is greater than the RTT of the SI (RTT_SI) or difference between the RTT_SI and RTT_PI is greater than a threshold value of RTT (RTT_TH), then there is a throughput problem and in order to get a better throughput, the PI is switched at step 1014 to LTE.

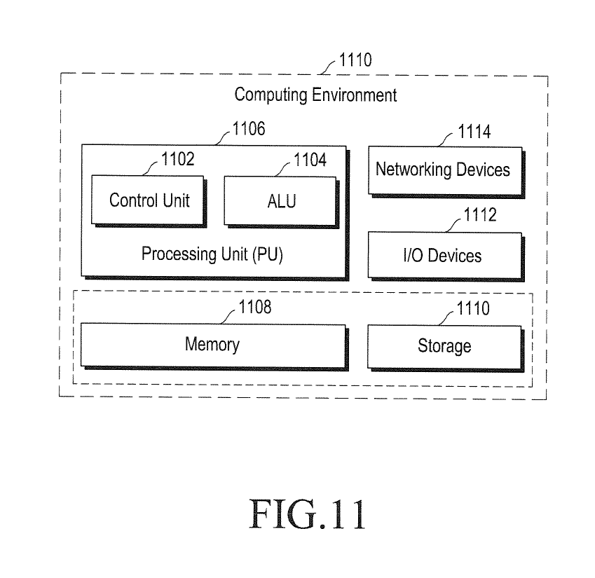

FIG. 11 illustrates a computing environment 1100 implementing a method of managing communication interfaces for a multipath transmission control protocol (MPTCP) connection, according to an embodiment as disclosed herein. As depicted in the FIG. 11, the computing environment 1100 comprises at least one processing unit 1106 that is equipped with a control unit 1102, an arithmetic logic unit (ALU) 1104, a memory 1108, a storage unit 1110, a plurality of networking devices 1114 and a plurality Input output (I/O) devices 1112. The processing unit 1106 is responsible for processing the instructions of the technique. The processing unit 1106 receives commands from the control unit 1102 in order to perform its processing. Further, any logical and arithmetic operations involved in the execution of the instructions are computed with the help of the ALU 1104.

The overall computing environment 1100 can be composed of multiple homogeneous or heterogeneous cores, multiple CPUs of different kinds, special media and other accelerators. The processing unit 1106 is responsible for processing the instructions of the technique. Further, the plurality of processing units 1106 may be located on a single chip or over multiple chips.

The technique comprising of instructions and codes required for the implementation are stored in either the memory unit 1108 or the storage 1110 or both. At the time of execution, the instructions may be fetched from the corresponding memory 1108 or storage 1110, and executed by the processing unit 1106.

In case of any hardware implementations various networking devices 1114 or external I/O devices 1112 may be connected to the computing environment 1100 to support the implementation through the networking unit 1114 and the I/O device unit 1112.

The embodiments disclosed herein can be implemented through at least one software program running on at least one hardware device and performing network management functions to control the elements. The elements shown in FIGS. 1-11 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for communication by a device using a multipath transmission control protocol (MPTCP) connection, the method comprising:
establishing communication with an endpoint using a primary interface of the device;
detecting an event in the device; and
switching an interface for communication with the endpoint, from the primary interface to a secondary interface of the device according to the detected event.

2. The method of claim 1, wherein the event corresponds to at least one of a connection failure, a change in signal strength, a change in location and a change in throughput.

3. The method of claim 1, further comprising prior to establishing the communication with the endpoint, creating the primary interface as backup.

4. The method of claim 1, wherein after establishing the communication with the endpoint, the primary interface is created as backup prior to the event, wherein the primary interface is created as backup in response to a pre-defined condition.

5. The method of claim 1, wherein the method further comprises multiplexing the MPTCP connection between a first intermediate node and a second intermediate node.

6. The method of claim 5, wherein the primary interface is in the communication with the endpoint through the first intermediate node.

7. The method of claim 6, wherein the method further comprises initiating, by the secondary interface, the communication with the endpoint through the second intermediate node.

8. The method of claim 1, wherein the primary interface is a wireless-Fidelity (Wi-Fi) interface and the secondary interface is a Wi-Fi interface.

9. The method of claim 1, wherein the primary interface is a Wi-Fi interface and the secondary interface is one of a global system for mobile communication (GSM) interface, a universal mobile telecommunication system (UMTS) system interface, and a long term evolution (LTE) interface.

10. The method of claim 1, wherein the primary interface is one of a GSM interface, a universal mobile telecommunication system UMTS system interface and a LTE interface, and the secondary interface is a Wi-Fi interface.

11. The method of claim 1, wherein the primary interface is a subscriber identity module (SIM) and the secondary interface is a SIM, in the device, wherein the device is a dual-SIM-dual-standby (DSDS) device.

12. The method of claim 1, wherein the primary interface is a SIM and the secondary interface is a SIM, in a communication device, wherein the device is a dual-SIM-dual-active (DSDA) device.

13. The method of claim 1, wherein the primary interface resides in the device and the secondary interface resides in a wearable device connected to the device.

14. A device for communication using a multipath transmission control protocol (MPTCP) connection, comprising:
a primary interface;
a secondary interface; and
a controller coupled to the primary interface and the secondary interface, wherein the controller is configured to:
establish communication with an endpoint using a primary interface of the device;
detect an event in the device; and
switch an interface for the communication with the endpoint, from the primary interface to a secondary interface of the device according to the detected event.

15. The device of claim 14, wherein the event corresponds to at least one of a connection failure, a change in signal strength, a change in location and a change in throughput.

16. The device of claim 14, wherein the controller is further configured to prior to establishing the communication with the endpoint, create the primary interface as backup.

17. The device of claim 14, wherein the controller is further configured to after establishing the communication with the endpoint, creating the primary interface as backup prior to the event, in response to a pre-defined condition.

18. The device of claim 14, wherein the controller is further configured to multiplex the MPTCP connection between a first intermediate node and a second intermediate node.

19. The device of claim 18, wherein the primary interface is in the communication with the endpoint through the first intermediate node, and the controller is configured to initiate, by the secondary interface, the communication with the endpoint through the second intermediate node.

20. A computer program product for communication by a device using a multipath transmission control protocol (MPTCP) connection, comprising computer executable program code recorded on a computer readable non-transitory storage medium, the computer executable program code when executed causing the actions including:
establishing communication with an endpoint using a primary interface of the device;
detecting an event in the device; and
switching an interface for communication with the endpoint, from the primary interface to a secondary interface of the device according to the detected event.
